(19) United States
(12) Patent Application Publication
(10) Pub. No.: US 2011/0266954 A1
(43) Pub. Date: Nov. 3, 2011

(54) MULTIFUNCTIONAL RECHARGEABLE LED LIGHT

(76) Inventor: Shun Yee Lam, Hong Kong (CN)

(21) Appl. No.: 12/992,372

(22) PCT Filed: Aug. 28, 2009
(86) PCT No.: PCT/CN2009/000986

§ 371 Date: Nov. 12, 2010

(30) Foreign Application Priority Data
Jun. 11, 2009 (CN) 200920132723.1

(51) Int. Cl. H01J 7/44

(52) U.S. Cl. 315/33

(57) ABSTRACT

This invention relates to a type of multi-functional rechargeable energy saving LED light. Each of the existing lightings has only one function and use, and they are not convenient in respect of operation and portability, and thus cause a lot of inconvenience. This invention comprises a lamp base, a retractable tube, a lamp case, a lamp filter, LED bead(s) and a mounting board, a circuit board and a lithium battery. The retractable tube connects the lamp base to the lamp case. The LED bead(s) and mounting board are near the top of the lamp case where the lamp filter is located at the top on the surface of the lamp case. Power switch and indicator light are installed on the lateral side of the lamp case. The lithium battery is housed in the retractable tube while a circuit board is placed inside the lamp case. AC-DC constant voltage power module, a charge management module for the lithium battery, DC-DC constant current power module and a smart module are located on the circuit board (6).

### TECHNICAL FIELD

This invention relates to the field of electronic lighting device, and more particularly, relates to a type of multi-function rechargeable energy saving LED light.

### BACKGROUND ART

Currently, there are many types of lighting available in the market, such as illumination light, flashlight, fluorescent emergency light, etc. However each of them has only one function and use, and they are not convenient in respect of operation and portability. In addition, as the same light cannot be used for other purposes, this causes a lot of inconvenience to the user who has such need. For traditional lighting such as ordinary incandescent light and CFL energy saving fluorescent light, incandescent light is at the brink of elimination for its low efficiency, high heat emission and short life, while ordinary CFL fluorescent lights, though better than incandescent lights, emit light by ‘striking’ fluorescent powder with high voltage current which has a high power consumption but low light efficiency. Furthermore, a spot of fluorescent powder will decay or be ruined after repeated bombardment, which greatly shortens the life of a CFL energy saving light. The light is also environmentally unfriendly because mercury is used in it. Its other weaknesses include large heat output, high surface temperature, emissions of ultra-violet and infra-red rays which are harmful to human, and its casing is made of ordinary glass which is fragile and non-durable as well as relatively rough in appearance, affecting the effect of illumination.

### CONTENTS OF INVENTION

This goal of this invention is to provide users with a rechargeable energy saving LED light that is delicately designed, simple to use and carry, and integrates the functions of an illumination light, flashlight and fluorescent emergency light. It is also safe, environmental friendly, energy saving and long-life, and these merits are beneficial to its popularization.

The invention comprises the lamp base, retractable tube, lamp case, lamp filter, LED bead(s) and mounting board, circuit board and lithium battery. There is a retractable tube connecting the lamp base and the lamp case. The LED bead(s) (a number of beads may be used) and mounting board are near the top of the lamp case where a lamp filter is located at the top on the surface of the lamp case. Power switch and indicator light are installed on the lateral side of the lamp case. A circuit board is placed inside the lamp case while the lithium battery is housed in the retractable tube. On the circuit board are AC-DC constant voltage power module, charge management module for the lithium battery, DC-DC constant current power module and smart module.

As the light source is from LED, the aim of environmental protection, power saving and longer life can be achieved. With an extendable PC lamp case and lithium battery, it can serve as an emergency light during power failure, providing illumination with energy supplied by the lithium battery. The power switch on the lamp case enables the user to turn on or off the device at any time and thus it may be used as a flashlight. This is further supported by the built-in constant voltage and constant current function which ensure the stable operation of the LED beads. The above functions are all intelligently controlled by the smart module. The PC lamp filter attaching to the lamp case reduces glare and provides uniform and comfortable illumination beneficial to the human eyes

The advantages of this invention are that it has a delicate appearance, simple to use and carry, and integrates the functions of an illumination light, flashlight and fluorescent emergency light in a single device. It is also safe, environmental friendly, energy saving and long-life. It is equivalent to a portable multi-function lighting product, serving multiple purposes with great convenience. It may be extensively used in shop, hotel, display room, shopping mall, office, warehouse, public places and at home. It can also replace incandescent lights and CFL energy saving fluorescent lights directly, which will facilitate its popularisation.

### DESCRIPTION OF DRAWINGS

FIG. 1 is a perspective view of a LED light in accordance with the present invention;

FIG. 2 is a perspective view of the LED light with its retractable tube retracted;

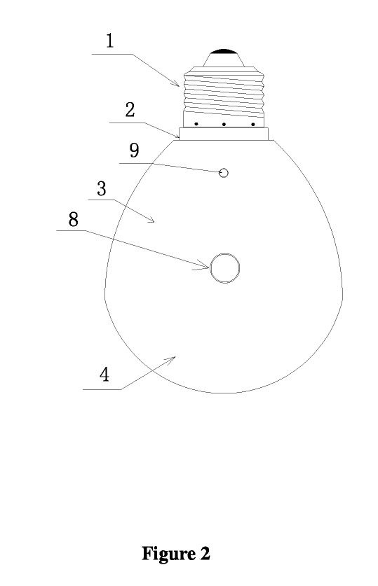

FIG. 3 is a perspective view of the LED light with lamp case, lamp filter, LED beads and mounting board;

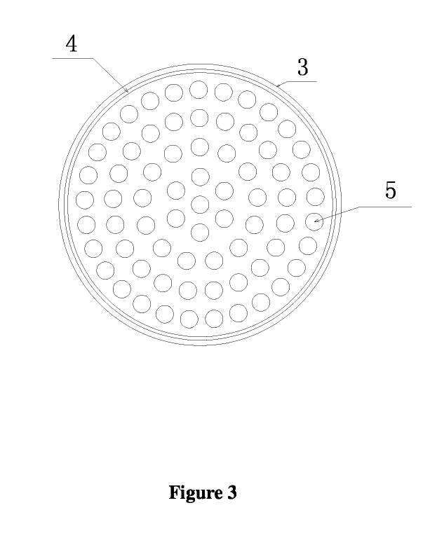

FIG. 4 is a block circuit of the LED light.

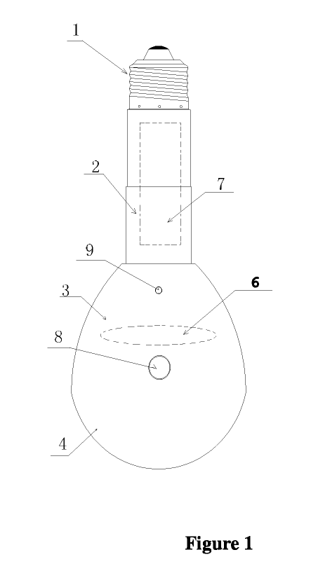

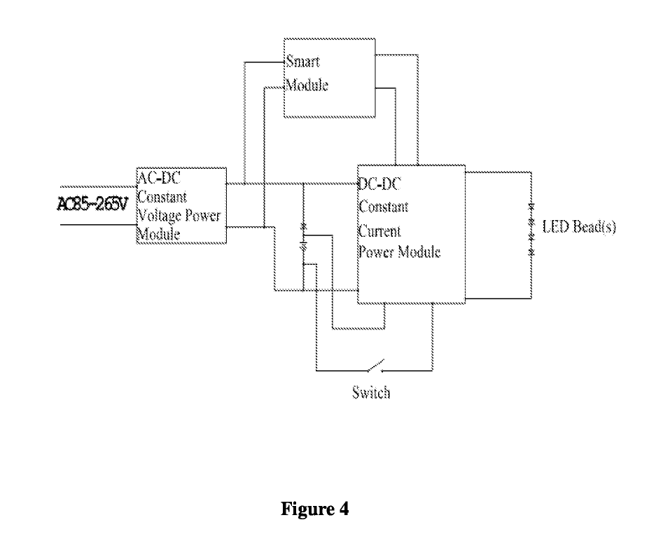

FIG. 1 shows, the lamp base (1), the retractable tube (2), the lamp case (3), the lamp filter (4), the LED bead(s) and mounting board (5), the circuit board (6), the lithium battery (7), the power switch (8) and the indicator light (9).

### EMBODIMENT OF THE INVENTION

The following is a further description of the invention in a preferred embodiment envisaged by the inventor as shown in the figures:

The invention comprises the lamp base (1), retractable tube (2), lamp case (3), lamp filter (4), LED bead(s) and mounting board (5), circuit board (6) and lithium battery (7). There is a retractable tube (2) connecting the lamp base (1) and the lamp case (3). The LED bead(s) (a number of beads may be used) and mounting board (5) are near the top of the lamp case (3) where a lamp filter (4) is located at the top on the surface of the lamp case (3). Power switch (8) and indicator light (9) are installed on the lateral side of the lamp case. A circuit board (6) is placed inside the lamp case (3) while the lithium battery (7) is housed in the retractable tube (2). AC-DC constant voltage power module, charge management module for the lithium battery, DC-DC constant current power module and smart module are located on the circuit board (6).

When the main power supply is normal, constant current is supplied to the LED bead(s) by the DC-DC constant current power module which in turn is provided with a stable DC voltage converted from the main power supply via a broad voltage AC85-265V input compatible AC-DC constant voltage power module. With such power supply, electricity and light conversion is completed to provide environmental friendly and soft light through the LED bead(s). During power supply failure, the smart module upon judging such situation would switch to the lithium battery circuit intelligently. Since the lithium battery (7) has a low DC voltage, it directly supplies a stable current to the LED bead(s) through a DC-DC constant current power module enabling the LED bead(s) to emit environmental friendly and soft light, serving the function of an emergency light. By extending the retractable tube (2), it can be used as a flashlight.

As for the size of the LED bead(s), there are two types of pins, namely [symbol] 3 (diameter 3 mm) and [symbol] 5 (diameter 5 mm), and 48-288 pieces of LED beads may be mounted on the mounting board.

It has five types of bases i.e. E27, E26, E14, E11 and GU10, which may be screwed on sockets with AC85-265V power supply.

1. A multi-functional rechargeable energy saving LED light comprising a lamp base (1), a retractable tube (2), a lamp case (3), a lamp filter (4), LED bead(s) and a mounting board (5), a circuit board (6) and a lithium battery (7);
the retractable tube (2) is connected to the lamp base (1) and the lamp case (3);
the LED bead(s) and the mounting board (5) are near the top of the lamp case (3) and the lamp filter (4) is located at the top on the surface of the lamp case (3);
the power switch (8) and indicator light (9) are installed on the lateral side of the lamp case (3);
the circuit board (6) is placed inside the lamp case (3) while the lithium battery (7) is housed in the retractable tube (2); and
a AC-DC constant voltage power module, a charge management module for the lithium battery, a DC-DC constant current power module and a smart module are located on the circuit board (6).

2. The multi-functional rechargeable energy saving LED light of claim 1, wherein the size of LED beads have two types of pins, namely diameter 3 mm ( [symbol] 3) and diameter 5 mm ( [symbol] 5), and that 48-288 pieces of LED beads may be mounted on the mounting board.

3. The multi-functional rechargeable energy saving LED light of claim 1, wherein the lamp base includes 5 types of lamp bases E27, E26, E14, E11 and GU10, which can be screwed on sockets with AC85-265V power supply.
